(19) United States
(12) Patent Application Publication
(10) Pub. No.: US 2010/0316345 A1
(43) Pub. Date: Dec. 16, 2010

(54) FIBER OPTIC PANEL AND METHOD

(76) Inventors: Michael Wentworth, Belle Plaine, MN (US); Mark Smrha, West Chicago, IL (US); Dean Rosenthal, West St. Paul, MN (US)

Correspondence Address: MERCHANT & GOULD PC, P.O. BOX 2903, MINNEAPOLIS, MN, 55402-0903, US

(21) Appl. No.: 12/762,784

(22) Filed: Apr. 19, 2010

Related U.S. Application Data
(60) Provisional application No. 61/170,960, filed on Apr. 20, 2009.

(51) Int. Cl. G02B 6/00; B23P 11/00

(52) U.S. Cl. 385/135; 29/428

(57) ABSTRACT

A fiber optic panel is provided including a front, and a rearwardly extending base. The base includes cable management structure including cable management fingers, cable ties, cable spools. The front defines fiber optic termination locations, including front removable adapters. The front includes a front face panel mounted to a rear face panel to enclose the fiber optic adapters.

### CROSS REFERENCE TO RELATED APPLICATION

This application claims the benefit of provisional application Ser. No. 61/170,960, filed Apr. 20, 2009, which is incorporated herein by reference in its entirety.

### FIELD OF THE INVENTION

This disclosure relates to devices for use in the telecommunications industry, and associated methods. More specifically, this disclosure relates to a cable management panel.

### BACKGROUND OF THE INVENTION

Many local area networks and telecommunications systems utilize panels and other structures to manage cables and cable terminations for cables extending between telecommunications equipment.

### SUMMARY OF THE INVENTION

The present disclosure relates to a panel having a front defining termination locations and a rearwardly extending base. The termination locations are defined by fiber optic adapters which connect to fiber optic connectors. Cable management structures are positioned on the base for managing cables extending to a rear of the panel for termination at the rear side of the termination locations. The front side of the termination locations allows access for patch cords or patch plugs for connecting to the rear sides of termination locations.

In one preferred embodiment, the front of the panel is positioned generally equal to the location of side flanges of the panel for mounting to a rack, frame, or cabinet. In one embodiment, the front is formed by a front face panel spaced from a rear face panel so as to cover front structures of the fiber optic adapters at the front of the panel. In one preferred embodiment, the adapters are not removable once the front face panel is mounted to the rear face panel.

The panel forms a fiber optic jack field with front accessible jacks. A non-protruding front structure in the preferred embodiment minimizes accidental contact with the panel and the fiber optic adapters.

### BRIEF DESCRIPTION OF THE DRAWINGS

FIG. 1 is a front perspective view of a first embodiment of a fiber optic panel in accordance with the present invention;

FIG. 2 is a rear perspective view of the panel of FIG. 1;

FIG. 3 is an exploded front perspective view of the panel of FIG. 1;

FIG. 4 is an enlarged view of a portion of the view of FIG. 3;

FIG. 5 is a top view of the panel of FIG. 1;

FIG. 6 is a front view of the panel of FIG. 1;

FIG. 7 is a front perspective view of a second embodiment of a fiber optic panel in accordance with the present invention;

FIG. 8 is a top view of the panel of FIG. 7;

FIG. 9 is a front view of the panel of FIG. 7;

FIG. 10 is a side view of the panel of FIG. 7;

FIG. 11 is a top view of a third embodiment of a fiber optic panel in accordance with the present invention.

### DETAILED DESCRIPTION

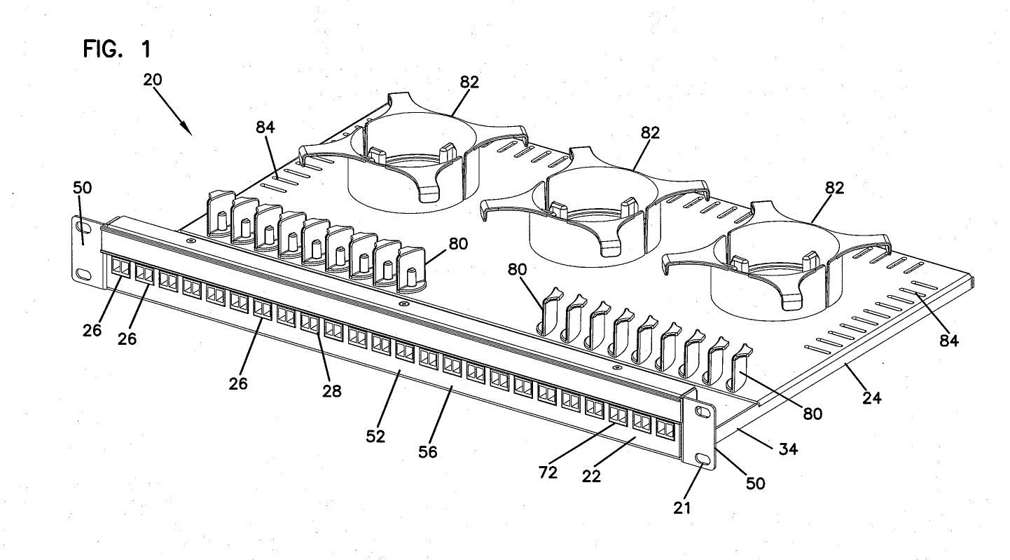

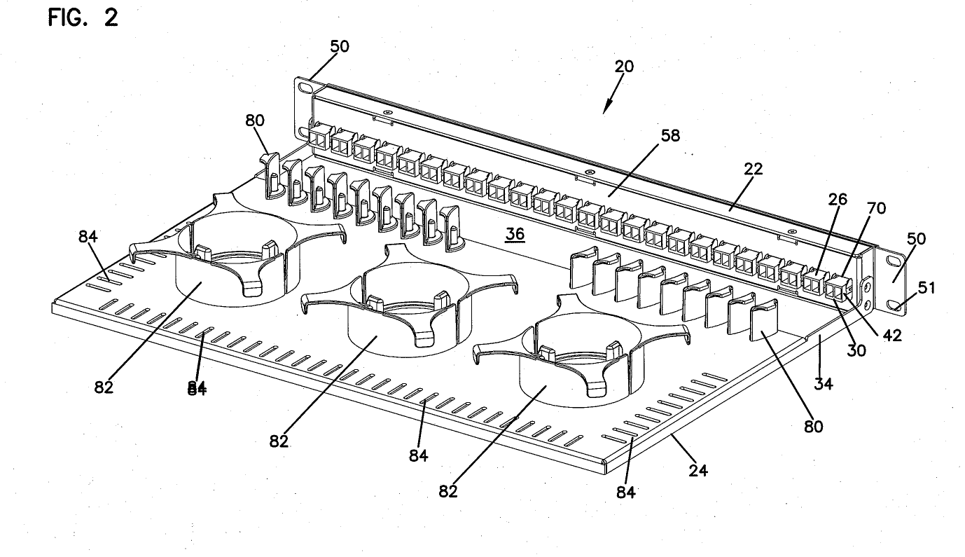

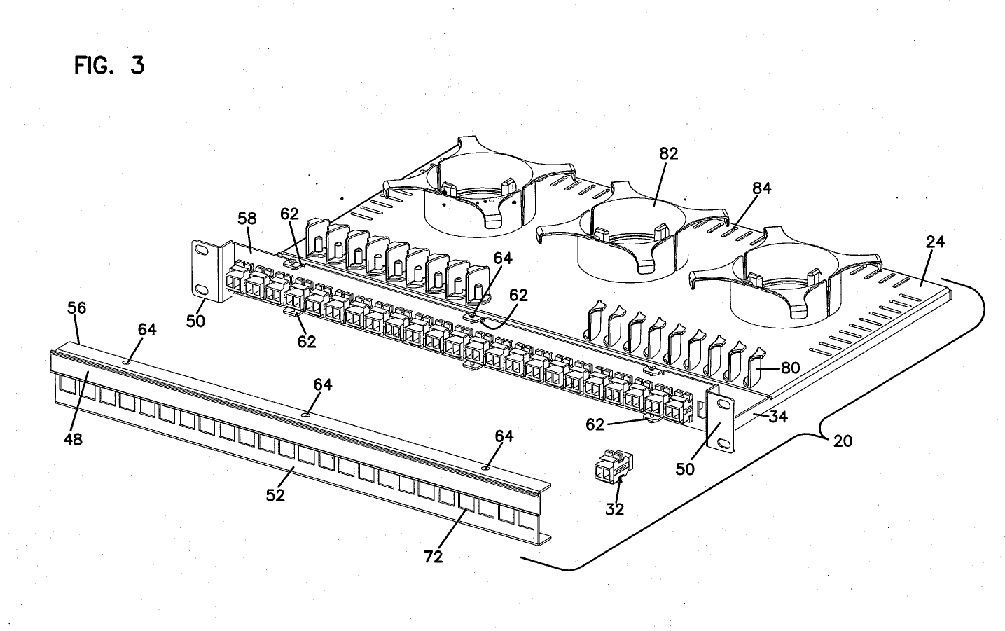

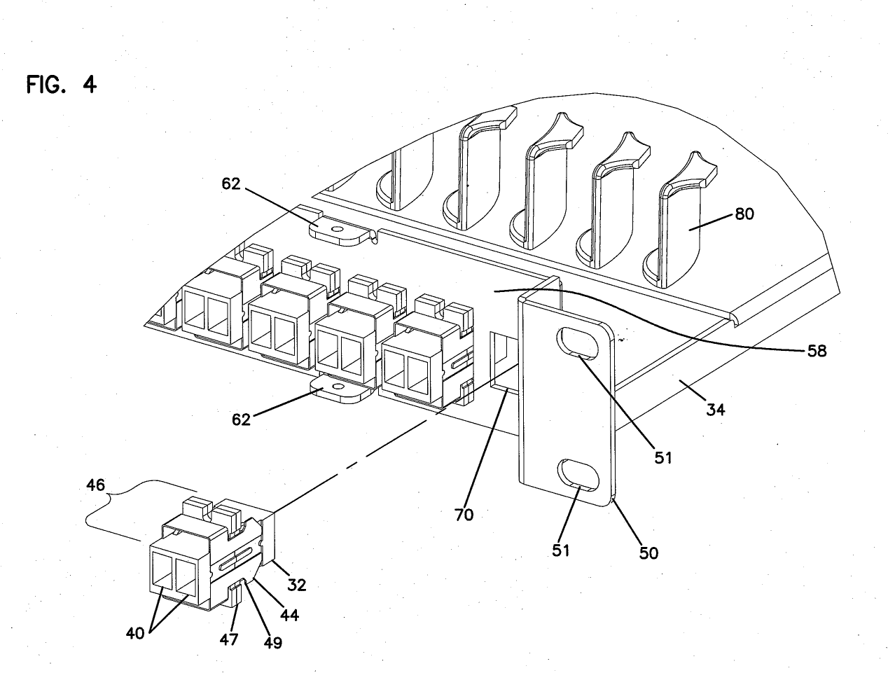

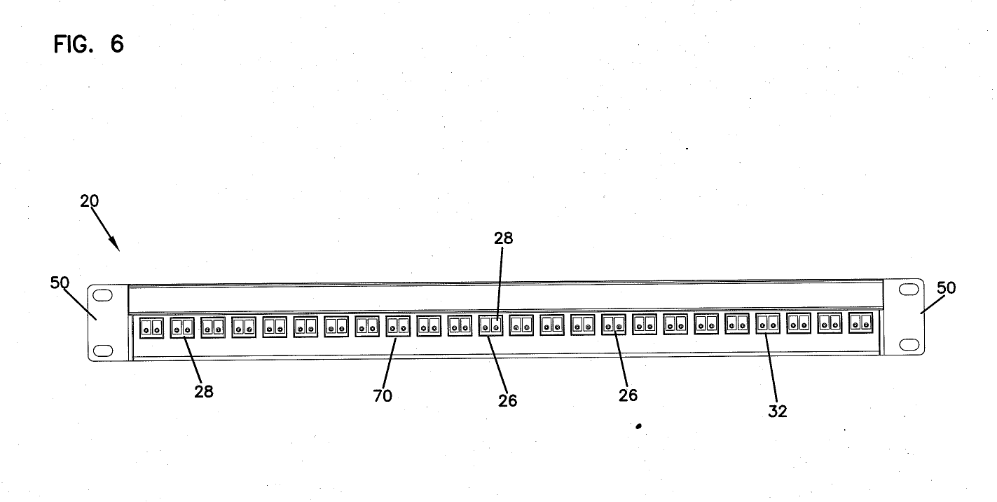

Referring now to FIGS. 1-6, a fiber optic panel 20 in accordance with the present invention includes a front 22 and a rearwardly extending base 24. Fiber optic cable termination locations 26 are defined in front 22. Each of the cable termination locations 26 includes a front termination 28 and a rear termination 30. Front and rear terminations 28, 30 allow for two fiber optic connectors to be positioned in alignment for signal transmission. In the illustrated embodiment, terminations 26 are formed by fiber optic adapters 32. A wide variety of adapters 32 can be used. Example adapters are shown in U.S. Pat. Nos. 7,153,033 and 7,182,524, the disclosures of which are incorporated by reference.

Fiber optic adapters 32 in the illustrated embodiment are duplex adapters and include two front openings 40, and two rear openings 42. Each opening 40, 42 can receive either an LC or an LX.5 fiber optic connector in the illustrated embodiment. It is to be appreciated that other adapters can be used, including simplex adapters, and dedicated adapters (e.g. only LC type or only LX.5 type). A clip mechanism 44 mounts each adapter 32 to panel 20.

U.S. Pat. No. 7,182,524 shows an example adapter that can receive multiple formats of connectors. U.S. Pat. No. 7,153,033 shows front accessible clips that operate like clip mechanism 44. U.S. Pat. No. 7,182,524 also shows a front accessible clip. Clip mechanism 44 allows for adapter 32 to mount to opening 70 from the front of panel 20.

Terminations 26 can be utilized in a variety of manners. One such usage is to create a jack field with front accessible jacks 28 that can be connected with patch cords and/or patch plugs to equipment connected to the rear terminations 30.

Panel 20 includes various cable management structures on base 24. Example cable management structures include cable fingers 80, cable spools 82, and cable tie locations 84. The rear cable management structures manage the cables extending to the rear terminations 30. Slack can be managed with spools 82. Cable ties 84 and fingers 80 manage and protect the cables. Fingers 80 are in a single row. Other arrangements and devices can be used if desired.

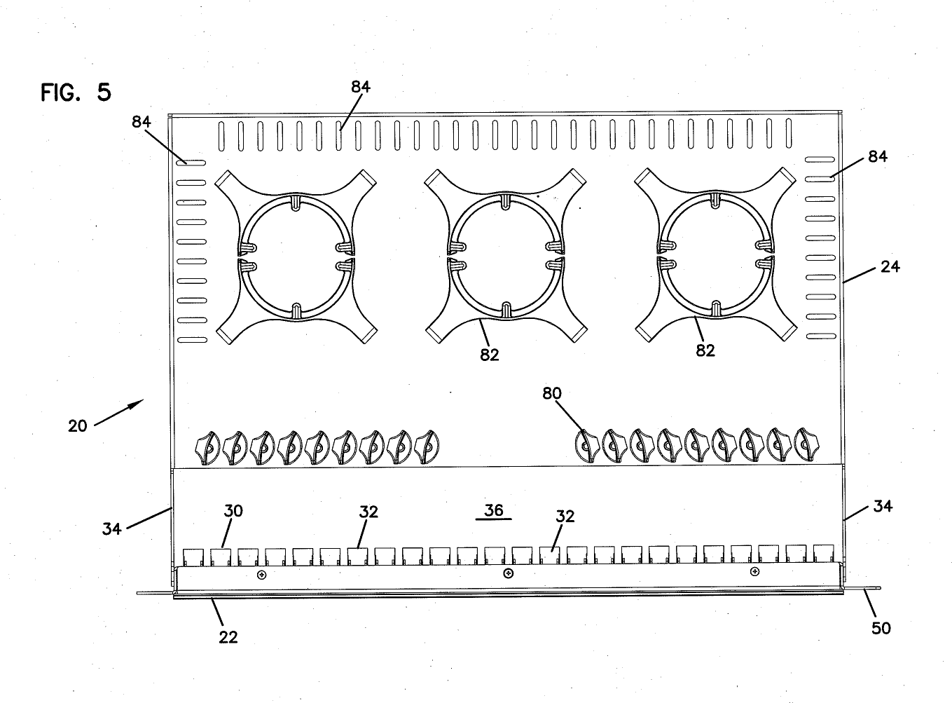

Panel 20 includes side flanges 50 with fastener holes 51 which allow for panel 20 to be mounted to a rack, frame, or cabinet as desired. As shown in FIG. 5, flanges 50 are generally in the same plane or close to a front plane defined by front 22 of panel 20. Front 22 is preferably formed by a front surface 52. Front 22 includes a front face panel 56 and a rear face panel 58 which together enclose front structures 46 associated with the adapters 32. Front face panel 56 and rear face panel 58 mount with tabs 62, and fasteners 66 in holes 64.

The adapters 32 are positioned in discrete openings 70 in rear face panel 58 and are front removable. Once front face panel 56 is mounted to rear face panel 58, the adapters are not removable with clip mechanism 44 since clip mechanism 44 is inaccessible. Each of the adapters 32 aligns with openings 72 in front face panel 56 for connector access. Clip shoulder 49 and flange 47 secure each adapter 32 to rear face panel 58.

As shown, front 22 is connected to base 24 by arms 34. An opening 36 is positioned adjacent to rear face panel 58, to allow technician access to the rear terminations 30.

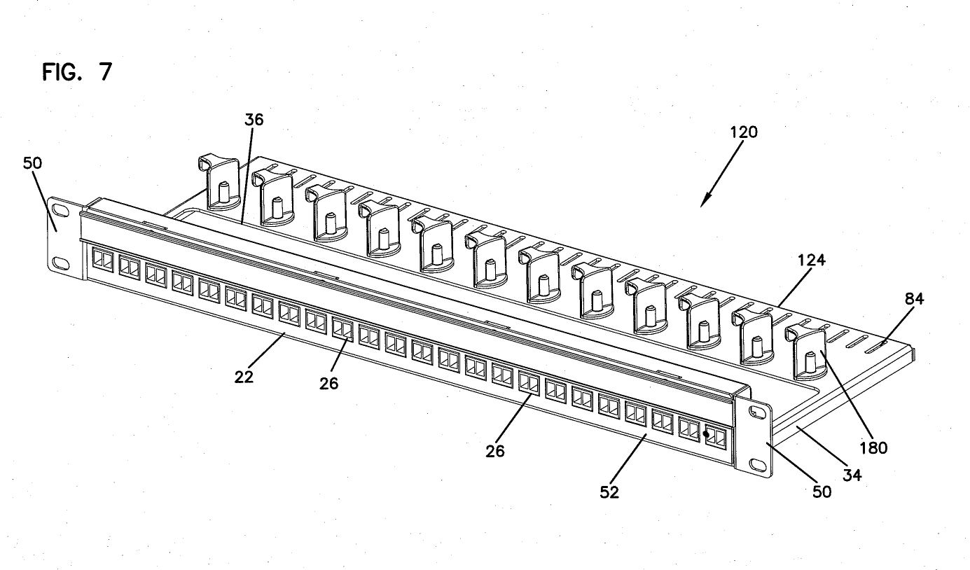

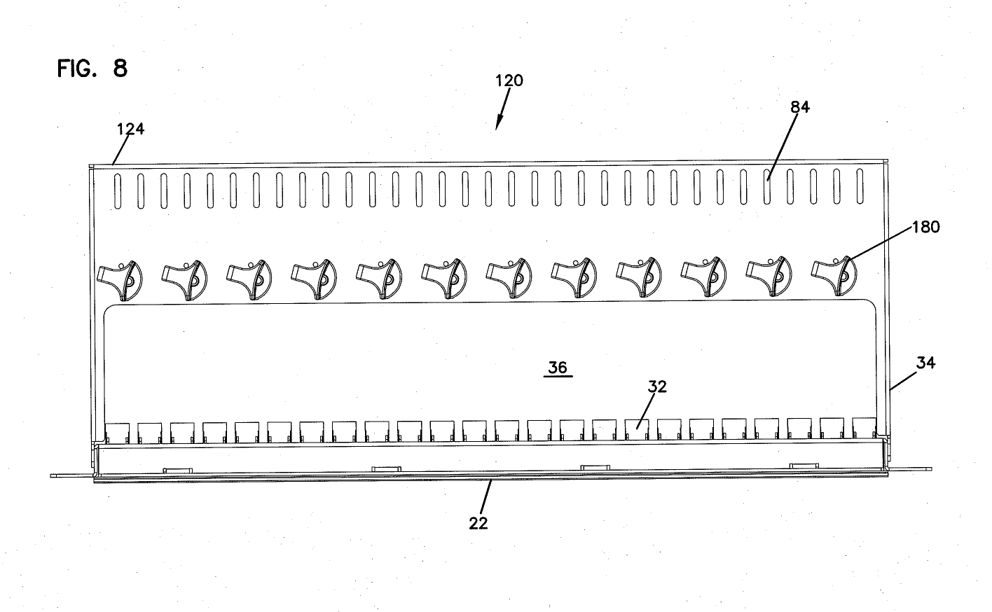

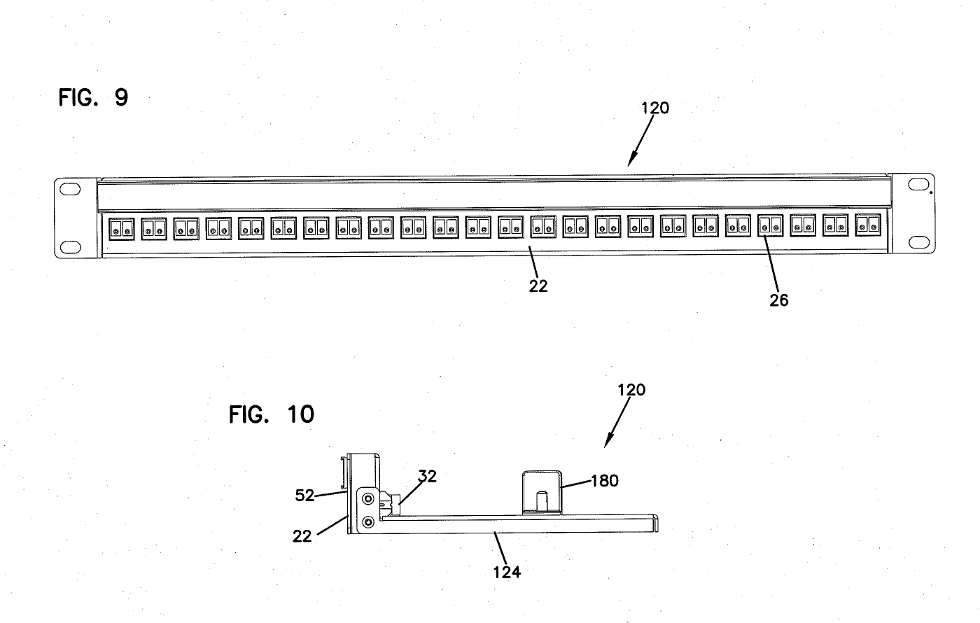

Referring now to FIGS. 7-10, an alternative embodiment of a panel 120 is shown with similar features as panel 20. Panel 120 does not include any spools like panel 20. Further, a different arrangement for cable fingers 80 is provided. As shown, cable fingers 180 direct all the cables in one direction. Panel 120 also includes a shorter base 124.

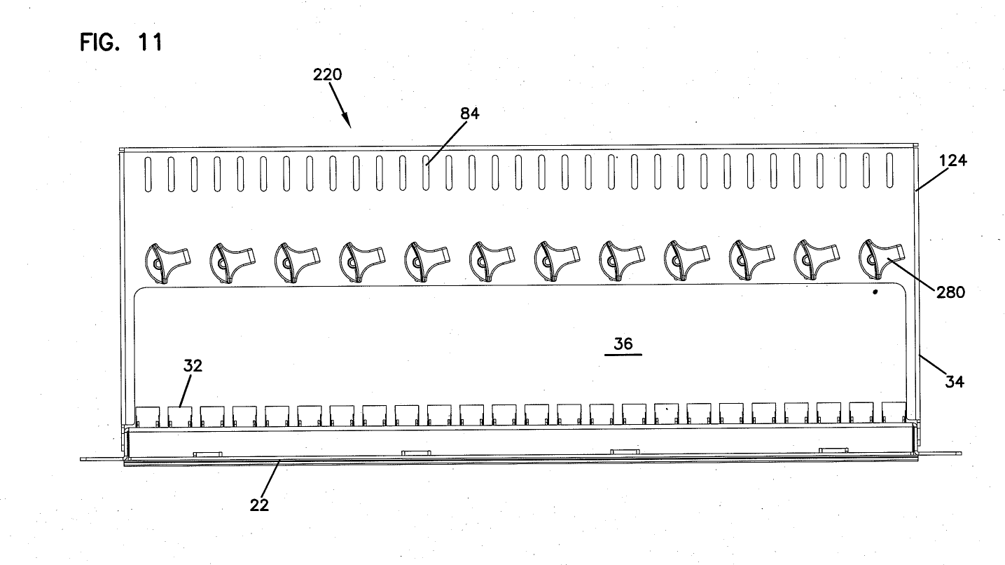

Referring now to FIG. 11, a further alternative embodiment of a panel 220 is shown where cable fingers 280 direct cables in an opposite direction to panel 120.

As shown, each of the cable termination locations 26 is in a single row across panel 20. Multiple rows can be provided, if desired. Indicia strip 48 can be used to label each of the jacks/termination locations 26.

With regard to the foregoing description, it is to be understood that changes may be made in detail, especially in matters of the construction materials employed and the shape, size and arrangement of the parts without departing from the scope of the present invention. It is intended that the specification and depicted aspects be considered exemplary only, with a true scope and spirit of the invention being indicated by the broad meaning of the following claims.

What is claimed is as follows:

1. A fiber optic panel comprising:
a front panel body including two ends and a middle portion, the ends defining flanges for mounting the panel to a vertical panel holding arrangement;
a rearwardly extending base;
wherein the front panel body defines a plurality of termination locations in the middle portion, each termination location including a fiber optic adapter for receiving a fiber optic connector;
wherein the base includes a plurality of cable guide fingers;
wherein the middle portion and the ends define a front plane, wherein the plurality of termination locations define front ends generally terminating at the front plane.

2. The panel of claim 1, wherein the front panel body includes a front face panel and a rear face panel spaced from one another to define an interior, wherein each fiber optic termination location is defined by a front removable adapter, wherein the adapter includes structure positioned on a front side of the rear face panel, wherein the front face panel is mounted generally flush with an end surface of the adapter.

3. The panel of claim 2, wherein the base defines an opening between the front panel body and the base, wherein the base is connected to the front panel body by two arms located adjacent to the ends of the front panel body.

4. The panel of claim 3, wherein the base includes cable tie slots.

5. The panel of claim 4, wherein the base includes at least one spool.

6. The panel of claim 1, wherein the base defines an opening between the front panel body and the base, wherein the base is connected to the front panel body by two arms located adjacent to the ends of the front panel body.

7. The panel of claim 1, wherein the base includes cable tie slots.

8. The panel of claim 1, wherein the base includes at least one spool.

9. A fiber optic panel comprising:
a front panel body including two ends and a middle portion, the ends defining flanges for mounting the panel to a vertical panel holding arrangement;
wherein the front panel body defines a plurality of termination locations in the middle portion, each termination location including a fiber optic adapter for receiving a fiber optic connector;
wherein the middle portion and the ends define a front plane, wherein the plurality of termination locations define front ends generally terminating at the front plane;
wherein the front panel body includes a front face panel and a rear face panel spaced from one another to define an interior, wherein each fiber optic termination location is defined by a front removable adapter, wherein the adapter includes structure positioned on a front side of the rear face panel, wherein the front face panel is mounted generally flush with an end surface of the adapter.

10. The panel of claim 9, further comprising a rearwardly extending base, wherein the base defines an opening between the front panel body and the base, wherein the base is connected to the front panel body by two arms located adjacent to the ends of the front panel body.

11. A fiber optic panel comprising:
a front panel body including two ends and a middle portion;
a rearwardly extending base;
wherein the front panel body defines a plurality of termination locations in the middle portion, each termination location including a fiber optic adapter for receiving a fiber optic connector;
wherein the middle portion and the ends define a front plane, wherein the plurality of termination locations define front ends generally terminating at the front plane;
wherein the front panel body includes a front face panel and a rear face panel spaced from one another to define an interior, wherein each fiber optic termination location is defined by a front removable adapter, wherein the adapter includes structure positioned on a front side of the rear face panel, wherein the front face panel is mounted generally flush with an end surface of the adapter, wherein the front face panel and the rear face panel include discrete openings each sized to receive one of the adapters;
flanges for mounting the panel to a vertical panel holding arrangement.

12. The panel of claim 11, wherein the base includes cable tie slots.

13. The panel of claim 11, wherein the base includes cable guide fingers.

14. The panel of claim 11, wherein the base includes at least one spool.

15. The panel of claim 11, wherein the base defines an opening between the front panel body and the base, wherein the base is connected to the front panel body by two arms located adjacent to the ends of the front panel body.

16. A method of assembly of fiber optic panel comprising:
providing a front panel body including two ends and a middle portion, the ends defining flanges for mounting the panel to a vertical panel holding arrangement, wherein the front panel body defines a plurality of openings sized for a fiber optic adapter for receiving a fiber optic connector, wherein the front panel body includes a front face panel and a rear face panel spaced from one another to define an interior;
mounting a front removable adapter to the rear face panel, wherein the adapter includes front structure positioned on a front side of the rear face panel;
mounting the front face panel to the rear face panel, wherein the front structure of the adapter is positioned in the interior, wherein the front face panel is mounted generally flush with an end surface of the front structure of the adapter.
